(19) United States
(12) Patent Application Publication
(10) Pub. No.: US 2007/0291202 A1
(43) Pub. Date: Dec. 20, 2007

(54) Reflective liquid crystal display

(76) Inventor: Tsuyoshi Sasaki, Kanagawa-ken (JP)

Correspondence Address: NATH & ASSOCIATES, 112 South West Street, Alexandria, VA, 22314, US

(21) Appl. No.: 11/808,649

(22) Filed: Jun. 12, 2007

(30) Foreign Application Priority Data
Jun. 16, 2006 (JP) P2006-167192

(51) Int. Cl. G02F 1/1335

(52) U.S. Cl. 349/113

(57) ABSTRACT

A reflective LCD includes reflective pixel electrodes, a counter electrode, and a liquid crystal layer arranged between the reflective pixel electrodes and the counter electrode. The reflective pixel electrodes are made of highly reflective metal material such as Al (aluminum) and Ag (silver). On each reflective pixel electrode, an electron emission suppressive layer is formed to suppress the emission of electrons from the surface of the reflective pixel electrode when the reflective pixel electrode is irradiated with read light.

### BACKGROUND OF THE INVENTION

1. Field of the Invention

The present invention generally relates to a reflective LCD (liquid crystal display) having reflective pixel electrodes that reflect read light to display an image. In particular, the present invention relates to a reflective LCD having reflective pixel electrodes made of highly reflective metal material such as Al (aluminum) and Ag (silver) and an electron emission suppressive layer that is formed on each reflective pixel electrode, to suppress the emission of electrons from the surface of the reflective pixel electrode when the reflective pixel electrode is irradiated with read light.

2. Description of Related Art

To display high-resolution images conforming to high-definition broadcasting standards and computer graphics SXGA standards on large screens, projection LCDs are widely used.

The projection LCDs are roughly classified into transmissive LCDs and reflective LCDs. The transmissive LCDs have a disadvantage that each TFT (thin film transistor) arranged in each pixel is not transmissive in a transmissive pixel area, to reduce an opening ratio of the pixel. Due to this, the reflective LCDs are attracting attention.

An example of the reflective LCD is an active matrix LCD having TFTs arranged in a matrix on an insulating layer formed on a substrate made of a conductive material, an interlayer insulating film formed to cover the TFTs, reflective pixel electrodes connected through signal lines to drains of the TFTs, a transparent counter electrode having optical transparency arranged above and opposite to the reflective pixel electrodes with a predetermined gap from the reflective pixel electrodes, and a liquid crystal layer sealed between the reflective pixel electrodes and the transparent counter electrode. The TFTs are operated in response to image signals to apply voltages between the reflective pixel electrodes connected to the TFTs and the transparent counter electrode, so that read light made incident from the transparent counter electrode side is optically modulated in the liquid crystal layer, is reflected by the reflective pixel electrodes, and is emitted outside from the transparent counter electrode, to display an image. This type of LCD is disclosed in, for example, Japanese Unexamined Patent Application Publication No. Hei 09(1997)-269482.

FIG. 1 is a vertical section showing the active matrix LCD disclosed in the Japanese Unexamined Patent Application Publication No. Hei 09(1997)-269482. FIG. 2 is a table of periodic law of elements showing the electric negative degrees of Al and Ag adopted to make reflective pixel electrodes of the active matrix LCD.

The active matrix LCD 100 shown in FIG. 1 has a substrate 101. The surface of the substrate 101 is oxidized to form an insulating film 102. On the insulating film 102, a polysilicon or amorphous silicon film for TFTs is formed. The TFTs are formed with a method used to form standard MOS transistors, so that each TFT 103 may have a gate 104, a drain 105, and a source 106. Between the drain 105 and the source 106, a channel 107 is formed.

A signal line 108 is connected to the source 106. A signal line 110 is formed to connect the drain 105 to a signal sustain capacitor 109 formed on the insulating film 102. Over the drain 105, source 106, channel 107, and signal sustain capacitor 109, a gate insulating film 111 is formed. On the gate insulating film 111 on the signal sustain capacitor 109, a capacitor gate 112 is formed. These elements are covered with an interlayer insulating film 113. The surface of the interlayer insulating film 113 is flattened, and a reflective pixel electrode 114 for light reflection is formed thereon. The reflective pixel electrode 114 is connected to the signal line 110.

On the reflective pixel electrode 114, a liquid crystal layer 115 with sealed liquid crystals is formed. Opposite to the reflective pixel electrode 114 and on the liquid crystal layer 115, a transparent electrode 116 is formed. On a bottom face of the substrate 101, a heat radiation plate 117 is arranged.

Operation of the active matrix LCD 100 of the related art will be explained. Read light L is made incident through the transparent electrode 116 and liquid crystal layer 115 to the reflective pixel electrode 114. At the same time, the TFT 103 is switched in response to an image signal, to apply a voltage between the reflective pixel electrode 114 connected to the TFT 103 and the transparent electrode 116. As a result, the read light L is optically modulated in the liquid crystal layer 115, is reflected by the reflective pixel electrode 114, and is emitted outside from the transparent electrode 116, to display an image. At this time, the signal sustain capacitor 109 sustains charge for the liquid crystal layer 115.

The reflective pixel electrode 114 is formed from highly reflective metal material such as Al (aluminum) and Ag (silver). These metal materials such as Al and Ag are known to have small electric negative degrees.

The “electric negative degree” indicates the force of an atomic nucleus attracting outermost electrons. The force of attracting electrons differs from element to element and is expressed as follows:

E=K×q/r² (1)

where E is the force of attracting electrons, K is a constant, r is a distance between an atomic nucleus and an outermost electron, and q is charge of the atomic nucleus.

In the table of periodic law of elements shown in FIG. 2, the distance r of an element becomes smaller as the position of the element in the table becomes higher in the same group. The atomic charge q, i.e., the electron attraction force E of an element becomes larger as the position of the element in the table becomes more right. An element having the largest electric negative degree is F (fluorine). According to the expression (1) or the table of FIG. 2, the electric negative degree of F is 3.98. An element having a large electric negative degree has a large electron attraction force, and an element having the largest electron attraction force is F.

On the other hand, the electric negative degree of Al (aluminum) used for the reflective pixel electrode 114 is 1.61 and that of Ag (silver) is 1.93. The electric negative degrees of Al and Ag are fairly smaller than that of F (fluorine).

It is known that Al and Ag have small work functions that are about 4.0 eV. If the surface of the reflective pixel electrode 114 is irradiated with light (short-wavelength light) whose energy exceeds the work function, the surface of the reflective pixel electrode 114 emits outermost electrons. The energy E of light is expressed as follows:

E=hν=hc/λ (2)

where h is a Plank constant, ν is the number of oscillations of the light, c is the speed of light, and λ is a wavelength of the light. With the constants substituted with numeric values, the wavelength and energy are expressed as follows:

λ(nm)=1240/E (eV) (3)

Namely, the wavelength of light whose energy exceeds a work function of 4.0 eV of Al or Ag is about 300 nm. If light whose wavelength is shorter than 300 nm is made incident to the reflective pixel electrode 114, the surface of the reflective pixel electrode 114 emits electrons.

The electrons emitted from the surface of the reflective pixel electrode 114 are accumulated in an interlayer part having a high impedance in the active matrix LCD 100. In the active matrix LCD 100, a layer having a highest impedance is an interface between the liquid crystal layer 115 and an alignment film (not shown) formed on each of the top and bottom faces of the liquid crystal layer 115. Accordingly, the emitted electrons accumulate in the interface of the alignment film formed on the reflective pixel electrode 114. Charge of the accumulated electrons produces a DC component, which is applied to the liquid crystal layer 115.

As mentioned above, the active matrix LCD 100 according to the related art employs the reflective pixel electrodes 114 made of highly reflective metal material such as Al and Ag. Read light L of large intensity made incident to each reflective pixel electrode 114 slightly contains light having short wavelengths smaller than 300 nm. The short-wavelength light causes the surface of the reflective pixel electrode 114 to emit electrons. These electrons create a DC component applied to the liquid crystal layer 115.

If the active matrix LCD 100 is operated with the DC components being applied to the liquid crystal layer 115, the LCD 100 will flicker, or when operated for a long time, will burn an image thereon due to segregation of ion impurities from the liquid crystal layer 115, thereby deteriorating the quality of images displayed with the LCD 100.

### SUMMARY OF THE INVENTION

An object of the present invention is to provide a reflective LCD capable of suppressing the emission of electrons from the surface of each reflective pixel electrode made of highly reflective metal material such as Al and Ag when read light containing short-wavelength light is made incident to the reflective pixel electrodes.

In order to accomplish the object, a first aspect of the present invention provides a reflective LCD including a semiconductor substrate, switching elements formed on a surface of the semiconductor substrate, reflective pixel electrodes formed over and connected to the switching elements, respectively, and made of metal material selected from the group consisting at least of Al and Ag, a liquid crystal layer arranged on the reflective pixel electrodes, and a transparent substrate having a counter electrode facing the reflective pixel electrodes, the switching elements being operated in response to image signals so that read light made incident from the transparent substrate side is optically modulated in the liquid crystal layer, is reflected by the reflective pixel electrodes, and is emitted outside from the transparent substrate to display an image. The reflective LCD has an electron emission suppressive layer formed on each of the reflective pixel electrodes, configured to suppress electrons to be emitted from a surface of the reflective pixel electrode when the surface of the reflective pixel electrode is irradiated with the read light.

According to a second aspect of the present invention, the electron emission suppressive layer is made of an element whose electric negative degree is larger than that of the metal material of the reflective pixel electrodes.

The electron emission suppressive layer of the reflective LCD mentioned above is formed on each of the reflective pixel electrodes by surface-treating the reflective pixel electrodes with an element whose electric negative degree is larger than that of the metal that makes the reflective pixel electrodes. The surface treatment terminates dangling bonds at the surface of each reflective pixel electrode. The electron emission suppressive layer suppresses electrons to be emitted from the surface of each reflective pixel electrode when the reflective pixel electrode is irradiated with read light. Suppressing the emission of electrons results in reducing direct-current components applied to the liquid crystal layer, thereby preventing the flickering and burning of the LCD, improving the reliability of the LCD, and increasing the quality of displayed images.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a vertical section showing an active matrix LCD according to a related art;

FIG. 2 is a table of periodic law of elements showing the electric negative degrees of Al and Ag used for reflective pixel electrodes of active matrix LCDs;

FIG. 3 is an enlarged vertical section showing a model of a pixel included in a reflective LCD according to an embodiment of the present invention;

FIG. 4A is a block diagram showing an active matrix drive circuit for the reflective LCD according to the embodiment of FIG. 3;

FIG. 4B is an enlarged circuit diagram showing a transistor (TR) part of FIG. 4A;

FIG. 5 is a view showing a model of a vacuum apparatus for forming an electron emission suppressive layer on each reflective pixel electrode in a process of manufacturing the reflective LCD according to the embodiment of FIG. 3;

FIG. 6 is a table showing measurement results of F/Al composition (atomic percentage) at the surface of a reflective pixel electrode 30 of each sample; and

FIG. 7 is a table showing test results of the samples shown in FIG. 6 in connection with a change in the potential Vcom of a counter electrode 35, the flickering of a displayed image, a burn level, and quality.

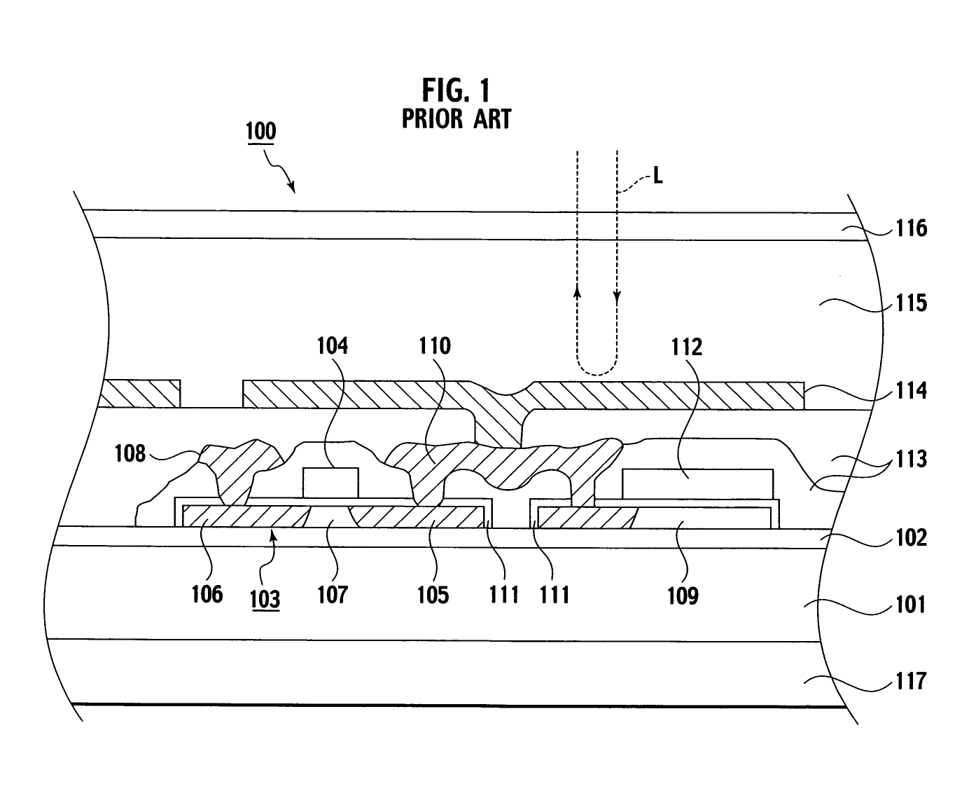

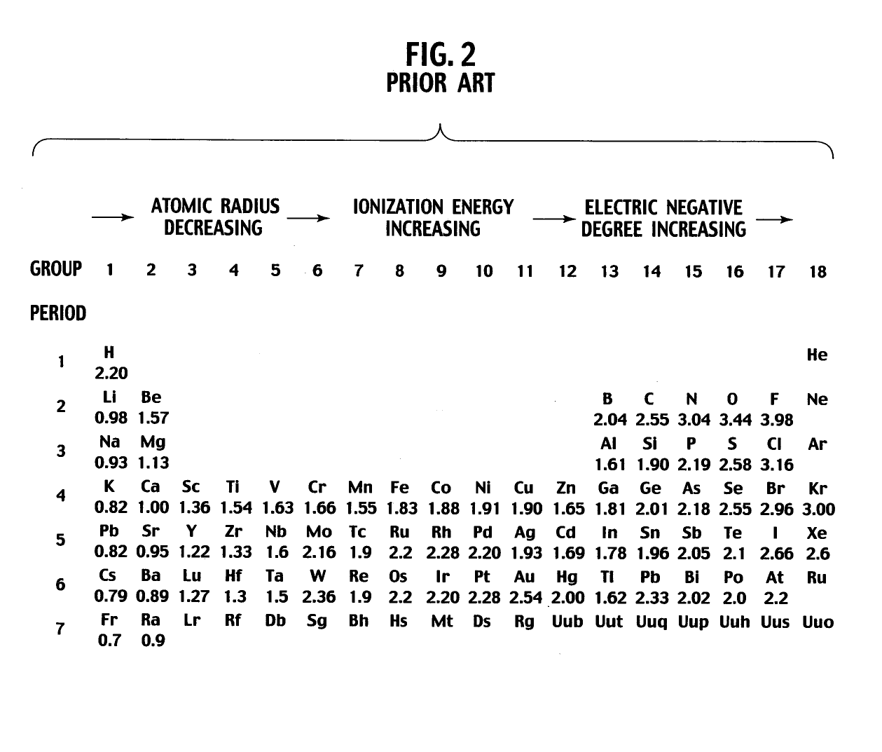

### DETAILED DESCRIPTION OF EMBODIMENTS

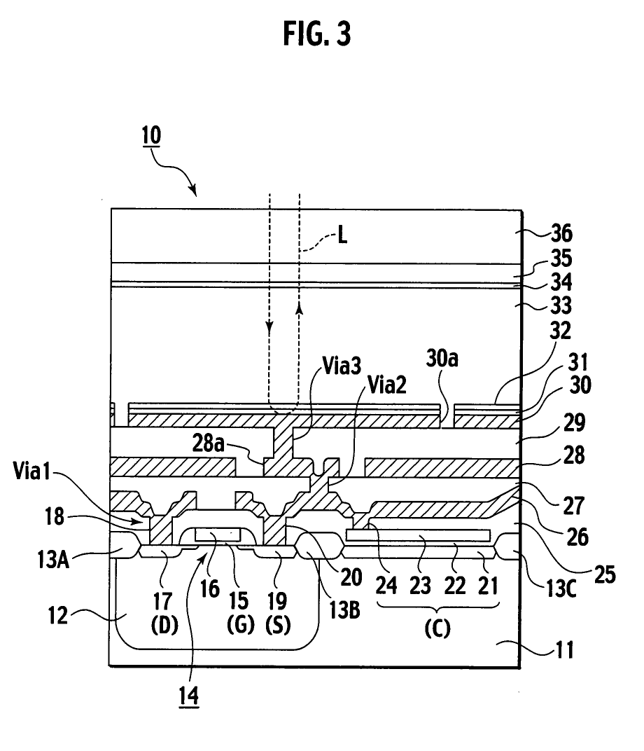

A reflective LCD according to an embodiment of the present invention will be explained in detail with reference to FIGS. 3 to 7.

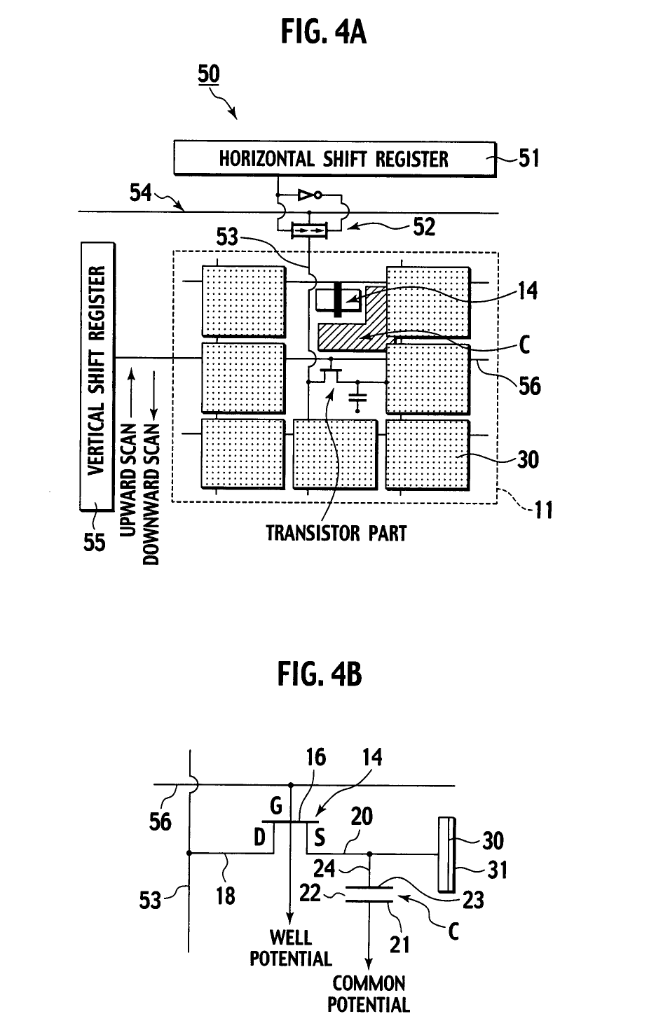

FIG. 3 is an enlarged vertical section showing a model of one of pixels arranged in the reflective LCD 10 according to an embodiment of the present invention. FIG. 4A is a block diagram showing an active matrix drive circuit for the reflective LCD 10 and FIG. 4B is an enlarged circuit diagram showing a transistor (TR) part of FIG. 4A.

The reflective LCD 10 shown in FIG. 3 is applicable to standard reflective projectors. For the sake of convenience, the following explanation is made in connection with an enlarged view of one of many pixels contained in the reflective LCD 10. A semiconductor substrate 11 is, for example, a p- or n-type monosilicon substrate. On the surface of the semiconductor substrate (hereinafter referred to as p-type Si substrate) 11, ape-well region 12 is formed. In each pixel, the ps-well region 12 is electrically isolated with field oxide films 13A and 13B. In the ps-well region 12, there is arranged a switching element 14 to be switched in response to an image signal. The switching element 14 is a MOSFET (metal oxide semiconductor field effect transistor).

The switching element (hereinafter referred to as MOSFET) 14 includes a gate oxide film 15 arranged substantially at the center of the surface of the p⁻-well region 12 and a gate electrode 16 made of polysilicon on the gate oxide film 15. The gate oxide film 15 and gate electrode 16 form a gate G.

On the left side of the gate G of the MOSFET 14 in FIG. 3, a drain region 17 is formed. On the drain region 17, a first via-hole Vial is formed. Aluminum wiring in the via-hole Vial forms a drain electrode 18 that forms, together with the drain region 17, a drain D.

On the right side of the gate G of the MOSFET 14 in FIG. 3, a source region 19 is formed. On the source region 19, a first via-hole Vial is formed. Aluminum wiring in the via-hole Vial forms a source electrode 20 that forms, together with the source region 19, a source S.

On the right side of the p⁻-well region 12 in FIG. 3, a diffused capacitor electrode 21 is formed on the p-type Si substrate 11 by ion implantation. In each pixel, the diffused capacitor electrode 21 is electrically isolated with the field oxide films 13B and 13C. In FIG. 3, an area from the field oxide film 13A to the field oxide film 13C defines the pixel in question.

On the diffused capacitor electrode 21, an insulating film 22 and a capacitor electrode 23 are formed in this order. On the capacitor electrode 23, there is a first via-hole Vial. Aluminum wiring in the via-hole Vial forms a capacitor electrode contact 24. These elements 21, 22, 23, and 24 form a sustain capacitor C.

Over the field oxide films 13A to 13C, gate electrode 16, and capacitor electrode 23, a first interlayer insulating film 25, a first metal film 26, a second interlayer insulating film 27, a second metal film 28, a third interlayer insulating film 29, and a third metal film 30 are layered in this order. These films are functional films.

The first, second, and third interlayer insulating films 25, 27, and 29 are made of, for example, insulative SiO₂ (silicon oxide).

The first and second metal films 26 and 28 are made of conductive metal material such as Al (aluminum). The third metal film 30 functions as a reflective pixel electrode, and therefore, is made of highly reflective metal material such as Al (aluminum) and Ag (silver).

The first, second, and third metal films 26, 28, and 30 are patterned in predetermined shapes, are contained in each pixel, and are associated with the MOSFET 14 of the pixel. In each pixel, the metal films 26, 28, and 30 are electrically connected to one another. The metal films 26, 28, and 30 in one pixel are electrically isolated from those in the adjacent pixels with openings 26a (not shown), 28a, and 30a of predetermined widths squarely formed around the metal films 26, 28, and 30.

In each pixel, the lowermost first metal film 26 is connected to the MOSFET 14 and the sustain capacitor C serving for the MOSFET 14.

In each pixel, the middle second metal film 28 serves as a light shield film that prevents part of read light L coming from a transparent substrate 36 (to be explained later) from reaching the MOSFET 14 located under the second metal film 28. For this, the second metal film (light shield film) 28 is formed to cover the opening 30a opened between adjacent third metal films 30, so that the second metal film 28 may block part of read light L entering the opening 30a. The second metal film 28 is connected to the lowermost first metal film 26 with aluminum wiring in a second via-hole Via2 that is formed through the second interlayer insulating film 27 by etching.

In each pixel, the uppermost third metal film 30 has a square shape and is isolated from adjacent third metal films 30 with the opening 30a to define a reflective pixel electrode. The third metal film 30 is connected to the second metal film 28 with aluminum or silver wiring in a third via-hole Via3 that is formed through the third interlayer insulating film 29 by etching.

On the reflective pixel electrode (third metal film) 30 that is made of highly reflective metal material such as Al (aluminum) and Ag (silver), an electron emission suppressive layer 31 is formed to suppress electrons to be emitted from the surface of the reflective pixel electrode 30 due to short-wavelength light contained in read light L. The electron emission suppressive layer 31 is an essential part of the present invention.

In the pixel shown in FIG. 3, one MOSFET 14 is provided with one reflective pixel electrode 30 connected to the MOSFET 14. Namely, on the p-type Si substrate 11, every pixel includes a pair of the MOSFET 14 and reflective pixel electrode 30 and every reflective pixel electrode 30 is provided with one electron emission suppressive layer 31 thereon.

The electron emission suppressive layer 31 is formed by surface-treating the reflective pixel electrode 30 with an element whose electric negative degree is greater than that of the metal material (Al or Ag) of the reflective pixel electrode 30. The surface treatment terminates dangling bonds at the surface of the reflective pixel electrode 30, to suppress the emission of electrons from the surface of the reflective pixel electrode 30 when the reflective pixel electrode 30 is irradiated with read light.

As mentioned above, Al (aluminum) has an electric negative degree of 1.61 and Ag (silver) has 1.93. Accordingly, the element having a larger electric negative degree than the metal material (Al or Ag) of the reflective pixel electrode 30 is preferably F (fluorine) having an electric negative degree of 3.98 in the halogen group, or Cl (chlorine) having an electric negative degree of 3.16 in the halogen group. Preferable elements outside the halogen group include C (carbon) having an electric negative degree of 2.55 and N (nitrogen) having an electric negative degree of 3.04. Any elements that have electric negative degrees larger than 2.5 and are easily available are acceptable for the present invention.

On the electron emission suppressive layer 31, an alignment film 32 is formed. On the alignment film 32, a liquid crystal layer 33 in which liquid crystals are sealed is formed. On the liquid crystal layer 33, an alignment film 34 is formed. On the alignment film 34, the transparent counter electrode 35 is formed to face the reflective pixel electrode 30. The counter electrode 35 transmits light, serves as a common electrode for all pixels, and is formed with, for example, ITO (indium tin oxide) without partitioning.

In the reflective LCD 10, the pixels on the p-type Si substrate 11 may be arranged in a matrix having rows and columns. An active matrix drive circuit for driving such a matrix of pixels will be explained with reference to FIGS. 4A and 4B.

In FIGS. 4A and 4B, a pair of the sustain capacitor C and reflective pixel electrode 30 is connected to the MOSFET 14, to form each pixel. The pixels are arranged in rows and columns on the p-type Si substrate 11, to form a matrix in the reflective LCD 10. The matrix is driven by the active matrix drive circuit 50.

To specify one of the pixels, a horizontal shift register 51 and a vertical shift register 55 are orthogonally arranged in column and row directions.

From the horizontal shift register 51, signal lines 53 are extended through video switches 52 in the column (vertical) direction. For the sake of simplicity, FIGS. 4A and 4B each show only one signal line 53 connected to the horizontal shift register 51. The signal line 53 supplies a video signal to the corresponding column. Between the horizontal shift register 51 and the video switch 52, the signal line 53 is connected to a video line 54. The signal line 53 is connected through the aluminum wiring of the first metal film 26 (FIG. 3) to the drain electrode 18 of every MOSFET 14 in the same column.

From the vertical shift register 55, gate lines 56 are extended in the row (horizontal) direction. For the sake of simplicity, FIGS. 4A and 4B each show only one gate line 56 connected to the vertical shift register 55. The gate lines 56 are used to sequentially supply a gate pulse to the rows in a scan direction. The gate line 56 is connected through polysilicon to the gate electrode 16 of every MOSFET 14 in the same row.

The source electrode 20 of the MOSFET 14 is connected through the aluminum wiring of the first metal film 26 (FIG. 3) and the capacitor electrode contact 24 to the capacitor electrode 23 of the sustain capacitor C. The source electrode 20 is also connected through the aluminum wiring of the first and second metal films 26 and 28 (FIG. 3) to the reflective pixel electrode 30.

The active matrix drive circuit 50 employs a frame inversion driving method that is known to those skilled in the art. Video signals are inverted between positive and negative polarities frame by frame. For example, video signals are positively written in an “n”th frame and are negatively written in an “n+1”th frame. The signal line 53 for passing a video signal may be connected to any one of the drain electrode 18 and source electrode 20 of the MOSFET 14. In the embodiment, the signal line 53 is connected to the drain electrode 18. If the signal line 53 is connected to the source electrode 20 of the MOSFET 14, the drain electrode 18 of the MOSFET 14 is connected to the sustain capacitor C and reflective pixel electrode 30.

The reflective LCD 10 needs a fixed well potential supplied to the MOSFET 14 and a common potential supplied to the sustain capacitor C.

The well potential supplied to the MOSFET 14 is a fixed potential of, for example, 15 V and is applied between the gate line 56 and a well potential contact formed on a p⁺ region (not shown) in the p⁻-well region 12 (FIG. 3). If an n-type Si substrate is employed, the well potential may be, for example, 0 V.

The common potential supplied to the sustain capacitor C is a fixed potential of, for example, 8.5 V and is applied between the capacitor electrode 24 of the sustain capacitor C and a common potential contact (not shown) on the diffused capacitor electrode 22. For the sustain capacitor C, the common potential may be of any voltage. It may be a center value (f or example, 8.5 V) of a video signal, so that the voltage applied to the sustain capacitor C may be about a half of a power source voltage. In this case, a withstand voltage of the sustain capacitor C may be about a half of the power source voltage. Then, it is possible to thin only the insulating film 22 of the sustain capacitor C, to increase a capacitance value. The larger the sustain capacitance value of the sustain capacitor C, the smaller the variation in the potential of the reflective pixel electrode 30 and higher the effect of reducing the flickering and burning of the liquid crystal layer 33 (FIG. 3).

The sustain capacitor C accumulates charge according to a potential difference between a potential applied to the reflective pixel electrode 30 and the common potential, maintains a voltage for the MOSFET 14 during an unselected period in which the MOSFET 14 is in an OFF state, and continuously applies a sustain voltage to the reflective pixel electrode 30.

To drive a pixel of the reflective LCD 10 by the active matrix drive circuit 50, a video signal is passed through the video line 54 and video switch 52 to the signal line 53 to which the pixel in question is connected. The MOSFET 14 at an intersection of the signal line 53 and gate line 56 is selected and turned on.

The reflective pixel electrode 30 of the selected MOSFET 14 receives the video signal through the signal line 53 and writes the video signal as charge in the sustain capacitor C. Between the selected reflective pixel electrode 30 and the counter electrode 35 (FIG. 3), a potential difference occurs depending on the video signal, to modulate an optical characteristic of the liquid crystal layer 33. As a result, read light L (FIG. 3) made incident from the transparent substrate 36 side is optically modulated in the liquid crystal layer 33 of the pixel. The modulated light is reflected by the reflective pixel electrode 30. At this time, the electron emission suppressive layer 31 formed on the reflective pixel electrode 30 suppresses the emission of electrons from the surface of the reflective pixel electrode 30 due to short-wavelength light contained in the read light L. The reflected light from the reflective pixel electrode 30 is emitted outside from the transparent substrate 36. Unlike the transmissive LCDs, the reflective LCD 10 according to the embodiment can utilize read light L nearly 100% to realize both high definition and high brightness on projected images. The reflective LCD 10 causes no flickering or burning, to improve the quality of displayed images and the reliability of the LCD.

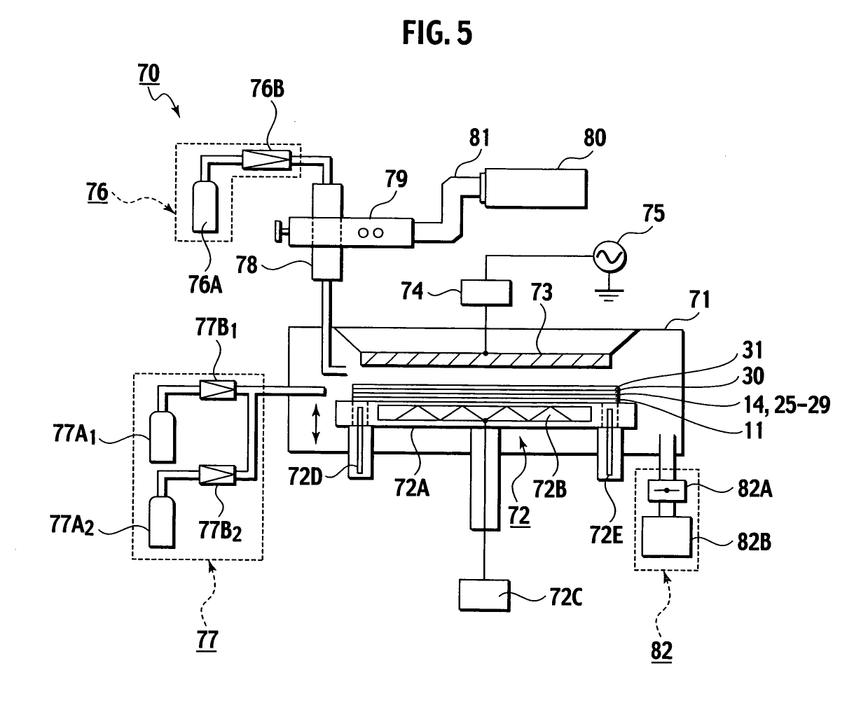

Forming the electron emission suppressive layer 31 on the reflective pixel electrode 30 during the manufacturing of the reflective LCD 10 will be explained with reference to FIG. 5.

FIG. 5 shows a model of a vacuum apparatus used to form an electron emission suppressive layer on a reflective pixel electrode during the manufacturing of a reflective LCD according to the present invention.

In FIG. 5, the vacuum apparatus 70 forms, on a semiconductor substrate 11 explained with reference to FIG. 3, functional films 25 to 29 and reflective pixel electrodes (third metal film) 30 from highly reflective metal material such as Al and Ag. Thereafter, a surface treatment is carried out with, for example, a halogen group element in a reaction chamber 71, to form an electron emission suppressive layer 31 on the reflective pixel electrodes 30. An example of the halogen group element is F (fluorine) contained in a reactive gas of SiF₄, NF₃, CF₄, CHF₃, or the like.

At a lower part of the reaction chamber 71 of the vacuum apparatus 70, there is a substrate heater 72. The substrate heater 72 includes a heater 72B arranged inside a stage 72A on which the semiconductor substrate 11 is placed. The heater 72B is controlled by a heat controller 72C. The stage 72A is vertically movable with lift pins 72D and 72E. In an initial state before carrying out the surface treatment, the semiconductor substrate 11 is placed on the stage 72A with the reflective pixel electrodes 30 being in a top layer.

At an upper part of the reaction chamber 71 of the vacuum apparatus 70, a high-frequency electrode 73 is arranged in parallel with and separated from the semiconductor substrate 11 placed on the stage 72A. The high-frequency electrode 73 generates glow discharge to decompose reactive gas. The high-frequency electrode 73 is connected through an impedance matching circuit 74 to a high-frequency power source 75. The high-frequency power source 75 generates a high-frequency of 13.56 to 75 MHz.

On the left side of the reaction chamber 71 of the vacuum apparatus 70, there are a first gas introduction unit 76 and a second gas introduction unit 77. At least one of the first and second gas introduction units 76 and 77 is used according to this embodiment.

The first gas introduction unit 76 has a tank 76A containing a reactive gas of one of SiF₄, NF₃, CF₄, and CHF₃ and a valve 76B.

The second gas introduction unit 77 has tanks 77A1 and 77A2 each containing a reactive gas of one of SiF₄, NF₃, CF₄, and CHF₃ and valves 77B1 and 77B2. The tank 77A1 and valve 77B1 form one system, and the tank 77A2 and valve 77B2 form another system. The systems handle different kinds of reactive gases.

In the first gas introduction unit 76, the reactive gas contained in the tank 76A is sent through the valve 76B into a cavity 79 connected to a guide pipe 78. A microwave oscillator 80 generates a microwave, which is passed through a waveguide 81 into the cavity 79. In the cavity 79, the microwave activates the reactive gas into plasma to produce atomic fluorine or fluorine radicals, which are sent through the guide pipe 78 into the reaction chamber 71.

In the second gas introduction unit 77, one of the tanks 77A1 and 77A2 is selected with the use of the valves 77B1 and 77B2, and the reactive gas in the selected tank is sent into the reaction chamber 71. In the reaction chamber 71, the reactive gas is activated with the high-frequency electrode 73 into plasma to produce atomic fluorine or fluorine radicals.

A lower right part of the reaction chamber 71 is provided with a reactive gas discharge unit 82 that has a cock 82A and a discharge pump 82B. After finishing the surface treatment of the reflective pixel electrodes 30, the reactive gas is discharged through the reactive gas discharge unit 82.

When the vacuum apparatus 70 with the above-mentioned configuration is operated, a reactive gas of one kind from one of the first and second gas introduction units 76 and 77, or reactive gases of the same kind from the first and second gas introduction units 76 and 77 are activated in the reaction chamber 71 into plasma as mentioned above, to generate atomic fluorine or fluorine radicals. Due to the atomic fluorine or fluorine radicals, the surface of each reflective pixel electrode 30 adsorbs fluorine to form an electron emission suppressive layer 31.

To make the surface of each reflective pixel electrode 30 adsorb fluorine, the temperature of the semiconductor substrate 11 may be in the range of 100 to 250° C. Atomic fluorine or fluorine radicals are produced from fluorine dissociated from a reactive gas of one of SiF₄, NF₃, CF₄, and CHF₃.

If a microwave is used to make plasma, no self-bias occurs in the semiconductor substrate 11. This results in reducing damages to the substrate 11 due to ion species.

The degree of the surface treatment on the reflective pixel electrodes 30 can be changed by changing the flow rate of the reactive gas, the temperature of the substrate, the output of the high-frequency power source, and the duration of the surface treatment.

In the reaction chamber 71 of the vacuum apparatus 70, the surface of each reflective pixel electrode 30 is exposed to an atmosphere of atomic fluorine or fluorine radicals, to form the electron emission suppressive layer 31 over the surface of each reflective pixel electrode 30.

To actually confirm the electron emission suppressive layer 31 formed on each reflective pixel electrode 30, a comparative sample and samples 1 to 5 are formed with reflective pixel electrodes 30 made of Al. The comparative sample is formed by carrying out no surface treatment on the reflective pixel electrode 30. The samples 1 to 5 are formed by carrying out surface treatment with a reactive gas of CF₄ for 2, 5, 10, 50, and 100 seconds, respectively, to coat the respective reflective pixel electrodes 30 with fluorine.

In each sample, the reflective pixel electrode 30 is formed to a thickness of 200 nm at a flow rate of 60 sccm of CF₄ gas, a substrate temperature of 100° C., and a high-frequency power source output of 250 W.

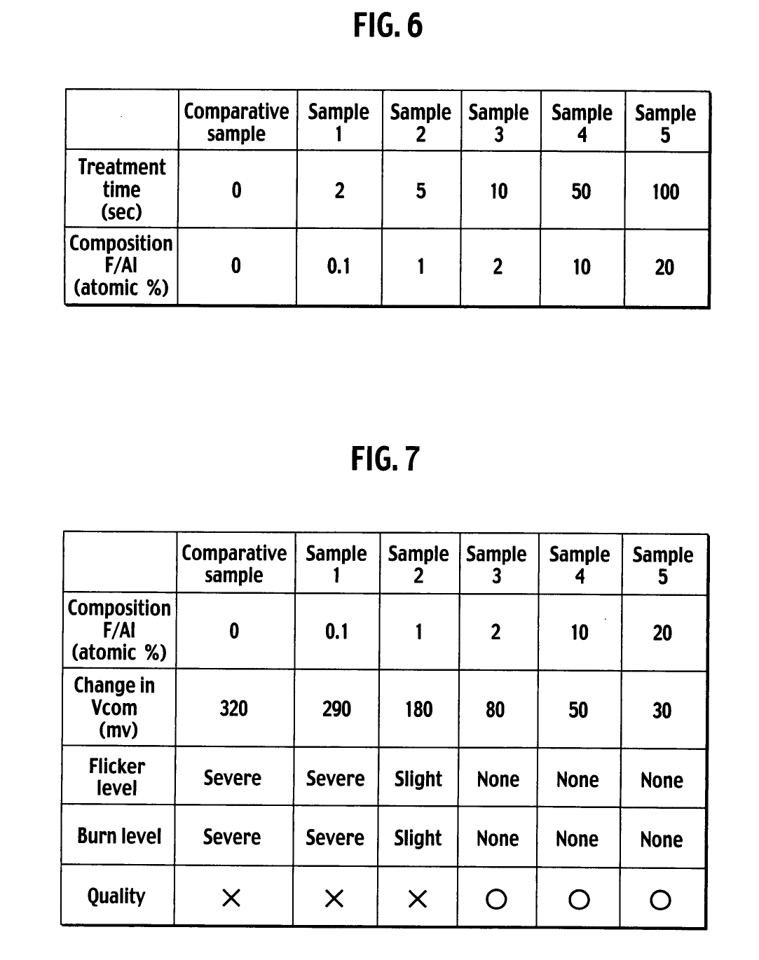

To find a surface composition of the reflective pixel electrode 30 of each sample, XPS (X-ray photoelectron spectroscopy) of Ulvac-Phi Inc. is used. The surface composition to be measured on each reflective pixel electrode 30 is F/Al (atomic percentage). Results are shown in FIG. 6.

In FIG. 6, the composition F/Al increases as the surface treatment time extends. When the surface treatment time extends to a certain extent, dangling bonds at the surface of the reflective pixel electrode 30 are saturated. Accordingly, a proper surface treatment time is about 100 seconds at the maximum.

In each of the comparative sample and samples 1 to 5, the reflective pixel electrode 30 faces a transparent counter electrode 35 with a liquid crystal layer 33 being positioned between them, to form a reflective LCD 10 as shown in FIG. 3. Short-wavelength read light is emitted toward the reflective pixel electrodes 30 of the comparative sample and samples 1 to 5, and on each sample, a change in the potential Vcom of the counter electrode 35, the flickering of a displayed image, the burning of the reflective LCD 10, and the quality of the reflective LCD 10 are measured. Results of the measurements are shown in a table of FIG. 7.

To measure a change in the potential Vcom of the counter electrode 35 of each sample, the reflective LCD 10 is inserted into a blue-light channel of a projector optical system, and the symmetry of an optical response waveform reflected by the LCD 10 is checked. The intensity of 300-nm light contained in the blue light is 3 mW/cm².

To measure the burning of the reflective LCD 10 of each sample, a fixed pattern is displayed with the LCD 10 for three hours with the blue-light being kept emitted. Thereafter, the LCD 10 is stopped and is evaluated with human eyes.

To measure the flickering of the reflective LCD 10 of each sample, a fixed pattern is displayed with the LCD 10 in an environment of 60° C. and an evaluation is made with human eyes.

In FIG. 7, “None” in “Flicker level” means that no flicker is observable with human eyes, “Slight” means that flickering is slightly observable with human eyes, and “Severe” means that flickering is clearly observable with human eyes. “Slight” and “Severe” in “Burn level” mean that the burning is observable with human eyes. In connection with the flicker level, “Slight” and “None” are accepted, and in connection with the burn level, only “None” is accepted.

As shown in FIG. 7, the samples 3 to 5 are qualified in each of the change of the potential Vcom of the counter electrode 35, the flicker level, and the burn level. The comparative sample and samples 1 and 2 are disqualified.

It is apparent from FIG. 7 that coating a reflective pixel electrode 30 with fluorine of 2 to 20 atomic percentage or more is effective to suppress a change in the potential Vcom of the counter electrode 35 within 80 mV with respect to read light and display images without flickering or burning.

Although the embodiment mentioned above surface-treats the reflective pixel electrodes 30 with fluorine, the surface treatment can be carried out with an element other than fluorine, such as chlorine, carbon, or nitride to substantially provide the same effect.

In this way, the reflective LCD 10 according to the above-mentioned embodiment of the present invention includes the reflective pixel electrodes 30 that are surface-treated with an element whose electric negative degree is larger than metal material of the reflective pixel electrodes 30. The surface treatment terminates dangling bonds at the surfaces of the reflective pixel electrodes 30 and forms the electron emission suppressive layer 31 on each of the reflective pixel electrodes 30, to suppress the emission of electrons from the surfaces of the reflective pixel electrodes 30 even when the reflective pixel electrodes 30 are irradiated with read light L containing short-wavelength light. Suppressing electron emission from the surfaces of the reflective pixel electrodes 30 against read light L reduces direct-current components applied to the liquid crystal layer 33, prevents the flickering and burning of the LCD 10, improves the quality of displayed images, and increases the reliability of the LCD 10.

It should be understood that many modifications and adaptations of the invention will become apparent to those skilled in the art and it is intended to encompass such obvious modifications and changes in the scope of the claims appended hereto.

What is claimed is:

1. A reflective LCD having a semiconductor substrate, switching elements formed on a surface of the semiconductor substrate, reflective pixel electrodes formed over and connected to the switching elements, respectively, and made of metal material selected from the group consisting at least of Al and Ag, a liquid crystal layer arranged-on the reflective pixel electrodes, and a transparent substrate having a counter electrode facing the reflective pixel electrodes, the switching elements being operated in response to image signals so that read light made incident from the transparent substrate side is optically modulated in the liquid crystal layer, is reflected by the reflective pixel electrodes, and is emitted outside from the transparent substrate to display an image, the reflective LCD comprising:
an electron emission suppressive layer formed on each of the reflective pixel electrodes, configured to suppress electrons to be emitted from a surface of the reflective pixel electrode when the surface of the reflective pixel electrode is irradiated with the read light.

2. The reflective LCD of claim 1, wherein:
the electron emission suppressive layer is made of an element whose electric negative degree is larger than that of the metal material of the reflective pixel electrodes.
